(19) United States
(12) Patent Application Publication
(10) Pub. No.: US 2008/0083593 A1
(43) Pub. Date: Apr. 10, 2008

(54) Shaft unit with sealing function relative to two axial pressure chambers and force transmission device with shaft unit

(75) Inventors: Christian Huegel, Rheinau (DE); Stephan Maienschein, Baden-Baden (DE)

Correspondence Address: Davidson, Davidson & Kappel, LLC, 485 17th Avenue, 14th Floor, New York, NY, 10018, US

(73) Assignee: LUK LAMELLEN UND KUPPLUNGSBAU BETEILIGUNGS KG, Buehl (DE)

(21) Appl. No.: 11/973,607

(22) Filed: Oct. 9, 2007

(30) Foreign Application Priority Data
Oct. 9, 2006 (DE) 102006047641

(51) Int. Cl. F16D 33/00; F16C 3/00

(52) U.S. Cl. 192/3.29; 464/162

(57) ABSTRACT

A shaft unit with two coaxial channels for coupling with two pressure chambers, disposed coaxial with the rotation axis of the shaft unit, which are sealed relative to each other through a seal device including a first hollow cylindrical element, forming a first channel; a second hollow cylindrical element enclosing the first hollow cylindrical element in circumferential direction, forming the other second channel, wherein the first hollow cylindrical element is coupled with the second one through a press connection. The first hollow cylindrical element is pressed together with the second hollow cylindrical element through an axial end section, protruding from the second hollow cylindrical element, wherein the first hollow cylindrical element has at least a radially extending protrusion in its end section at the outer circumference, which is disposed offset in axial direction from a face side of the second hollow cylindrical element, forming a groove with this face side, and wherein the seal device is disposed in the groove.

This claims benefit of German Patent Application 10 2006 047 641.7, filed Oct. 9, 2006.

The invention relates to a shaft unit with integrated seal function, relative to two pressure chambers, in particular, coaxial pressure chambers, disposed in axial direction next to each other and furthermore relates to a force transmission device with such a shaft unit as a transmission input shaft.

### BACKGROUND

Units, comprising a force transmission device and a subsequent transmission, wherein the coupling between the force transmission device and the subsequent transmission is performed through the transmission input shaft of the transmission, are known in a plurality of embodiments. In an exemplary manner, the patent document DE 198 22 665 A1 is referred to. From it, a force transmission device is known, comprising a hydrodynamic speed-/torque converter as a start element, and a lockup clutch, associated therewith, to circumvent the power flow through the hydrodynamic component. The hydrodynamic speed-/torque converter, subsequently abbreviated as torque converter, comprises a pump wheel, a turbine wheel, and at least one stator wheel, wherein the pump wheel can be at least indirectly coupled with a drive unit, e.g. a drive motor. Thus the pump wheel has a so-called pump wheel shell, enclosing the turbine wheel in an axial direction, forming an axial gap, extending in an annular manner in a circumferential direction. The lockup clutch is located therein. In the simplest embodiment it is provided as a segmented friction clutch. Thus a first clutch element is coupled at least indirectly torque proof with the input of the force transmission device, in particular, the pump wheel, while a second clutch element, which can be brought at least into indirect engagement with the first element, this means it is directly or indirectly connected with the output of the force transmission device torque proof, through further elements, which e.g. have friction surfaces. Furthermore also the turbine wheel is coupled with the output of the force transmission device. In the simplest case, the coupling is performed through a so-called output hub. It is also conceivable, however, to form the outputs directly from the turbine wheel, or the second clutch element. The coupling of the output is then performed torque proof with the transmission input shaft, which quasi forms the interface between the force transmission device and the subsequent transmission. This interface can be an element of the transmission, or also of the force transmission device, and can then only be coupled with the transmission input. The association, according to the design is performed according to the embodiment and provision of the particular components in a modular manner. The lockup clutch can be operated with slip, or without slip. In the simplest case, it is actuated through a piston element. Thus, the piston element can already have a second coupling element, or it can impact this element. The piston element is thus connected torque proof with the drive, in particular, the converter housing, however, movable in axial direction relative to it. Through this axial arrangement, different pressure areas are formed. A first pressure chamber is thereby characterized by the arrangement between housing wall and piston element. A second pressure chamber is located between the piston and the hydrodynamic component. Through the pressure difference between the two, the operation of the lockup clutch is controlled.

In order to seal the second pressure chamber relative to the converter, a seal device is provided. It can be provided in different manners, and comprises in the simplest case seal elements in the form of O-rings or square profile rings. A multitude of possibilities is known for their arrangement. In the simplest case, the seal element is located in a hub in the converter cover. This, however, necessitates machining a respective groove into the converter cover, in particular, a surface forming an interior circumference. Furthermore, the insertion of the seal device is performed relative to an interior diameter.

According to another known embodiment, the single seal element of the seal device is disposed in a groove in the transmission input shaft. This groove, however, is machined into the area of the shaft end of the transmission input shaft, and, thereby, characterized through an increased manufacturing effort. Furthermore, with respect to connecting and relative positioning of particular connection bores in the transmission output shaft, with respect to coupling with respective chambers or channels at the hydrodynamic converter, a relatively high fit precision is required for machining the groove. Position adjustments are therefore only possible under certain conditions. Also, for machining the groove, a respective minimum wall thickness has to be provided at the transmission input shaft, which can lead to an unnecessary diameter increase. In embodiments with a placement of the seal element in a groove in the transmission input shaft, there is furthermore the disadvantage, that the seal element has to be drawn onto the outside diameter, and thus the smaller interior diameter of the seal element is expanded relative to the outer diameter of the transmission input shaft. This requires respective seal devices, which are designed accordingly with respect to material and sizing, in order not to destroy the seals already when drawing them on.

Another embodiment comprises pressing the seal element into the hub, in particular into the drive hub of the turbine wheel. This embodiment, however, is characterized by the same disadvantages as the embodiment including a step of pressing into the converter cover. In particular, an insertion of the seal is performed relative to an interior diameter.

### SUMMARY OF THE INVENTION

An object of the invention provides refining a shaft with a seal device, as described above, for sealing pressure chambers in the axial direction next to each other, and with at least two coaxial pressure media carrying channels, so that the said disadvantages are avoided. In particular, a cost effective, simple to manufacture and sizing optimized embodiment of a transmission input shaft with seal function should be emphasized. Thereby, the prerequisites with respect to compensating a radial offset and the speed difference between the input of a force transmission device and the transmission input shaft may be assured, when sealing two pressure chambers relative to each other.

The present invention provides a shaft unit with two coaxial channels for coupling with two pressure chambers, arranged coaxial to the rotation axis of the shaft unit, sealed relative to each other by a seal device, including a first hollow cylindrical element, forming a first channel, a second hollow cylindrical element, enclosing the first hollow cylindrical element in circumferential direction, forming the other second channel, wherein the first hollow cylindrical element is coupled with the second one through a press connection. According to the invention, the first hollow cylindrical element may be pressed together with an end section, protruding from the second hollow cylindrical element, wherein the first hollow cylindrical element comprises in its end section at the outer circumference a protrusion which is formed at least in radial direction, which is disposed with an offset in axial direction, relative to a face side of the second hollow cylindrical element, forming a groove with this face side, in which the seal device is disposed.

A solution, according to the invention, has the advantage that the seal device does not have to be drawn over the outer diameter of the shaft unit anymore, but due to the axial positioning, relative to each other, a drawing onto the inner, this means the first hollow cylindrical element, is preformed during assembly, and thus the inner circumference of the seal element does not have to be expanded. The insertion can already be performed before inserting the tubular element into the pass-through opening of the shaft.

Shaft units with two channels, disposed coaxial relative to each other, are typically formed by a shaft provided as a hollow shaft, which is connected torque proof with an element forming the inner channel. This inner element, which is formed by the first hollow cylindrical element, is thus preferably provided as a tube. According to the invention, the shaft and the tubular element may be disposed relative to each other, so that they form a groove for receiving the seal device with their face sides facing each other in the axial direction. Thus the second, preferably tubular element has an end section in the axial direction, which may be characterized through by outer diameter, which preferably corresponds to the outer diameter of the groove, and which is preferably equal to the outer diameter of the second hollow cylindrical element. Furthermore, the end section may be characterized in that it can be run into the pass-through opening at the shaft, and a torque proof coupling may be achieved. The torque proof coupling can be performed in the simplest case through a press connection. Correspondingly, the groove may be created through the axial alignment between the end section of the shaft and the tubular element. Thus, the face sides, pointing towards each other, of those two elements are used.

From a design point of view, thus the first hollow cylindrical element includes at least two sections, a first section and a second section, which may be characterized through different exterior dimensions. The first section forms the second channel with its outer circumference, and the second hollow cylindrical element. The second section is pressed into the second hollow cylindrical element, with at least part of its axial extension.

The present invention may also provide a protrusion as an annular protrusion, formed around the outer circumference of the first section of the hollow cylindrical element. In this case, a groove side surface is formed, which is closed in the circumferential direction, and a seal surface is formed on the opposite side, which can be used for sealing the first channel relative to further connection elements. In the simplest form, the protrusion may thus be provided as a flange.

In case it is not necessary to perform a seal of the differential pressure between two pressure chambers only in one direction, the seal function of the flange may be done away with. In this case, no rotation symmetrical flange is necessary. Radially formed segments provided as protrusions are sufficient. In this case, a plurality of protrusions is provided, which are disposed offset from each other in circumferential direction at the outer circumference of the end section, forming support areas for axial support, and positioning the seal device with their flange sections, facing away from the front face of the hollow cylindrical element carrying them.

Through the segmented design, the expansion of the seal ring during assembly is furthermore minimized, which occurs when drawing the seal ring over the flange section, so that an assembly would still be possible after pressing the tube end into the second hollow cylindrical element.

The solution according to the invention may be used in particular, when coupling between force transmission devices and transmissions in so-called transmission units. Thus the coupling of the shaft end may be performed in the section of the power transmission device, preferably through a respective drive hub, which is coupled torque proof with the connection elements, lockup clutches, and hydrodynamic speed-/torque converters.

### BRIEF DESCRIPTION OF THE DRAWINGS

The invention is subsequently described with reference to figures. These show the following in particular:

FIG. 1 illustrates the disposition of a shaft according to the invention in the form of a transmission input shaft in a transmission unit in a highly simplified illustration;

FIG. 2 illustrates the forming of the groove by the two elements, defining the shaft, in a detail view according to FIG. 1;

FIGS. 3a and 3b illustrate possible embodiments of the design of the flange section at the tubular element in two views.

### DETAILED DESCRIPTION

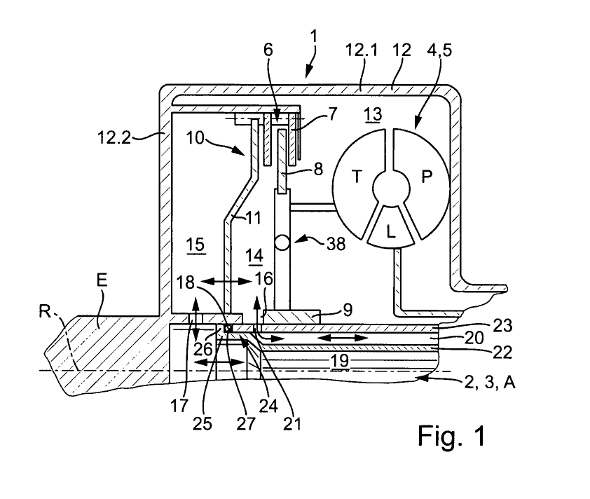

FIG. 1 illustrates in a schematic highly simplified view through a cutout from an axial sectional view of a force transmission unit 1 the disposition of a shaft unit 2 provided according to the invention in the form of a transmission input shaft 3. The power transmission device 1 comprises an input E and an output A, as well as a hydrodynamic component 4, which is provided in the depicted embodiment as a hydrodynamic speed-/torque converter, subsequently designated abbreviated as torque converter 5. Embodiments as a hydrodynamic clutch are also conceivable. The hydrodynamic torque converter 5 comprises a pump wheel P, which can be connected or coupled torque proof with the input E of the force transmission device 1, a turbine wheel T, which is coupled with the output A at least indirectly, this means directly, or through additional intermediary or functional elements, and at least one stator wheel L. The hydrodynamic torque converter 5 thus serves for converting speed and torque. Furthermore, the power transmission device 1 comprises a device for circumventing the hydrodynamic power transfer, which is also designated as lockup clutch 6. Thus, the lockup clutch 6 is disposed in parallel to the hydrodynamic component 4. The lockup clutch 6 thus serves for the circumvention of the power flow through the hydrodynamic component 4. This comprises a first, friction surface array 7, comprising at least one element having friction surfaces, wherein the friction surface array 7 is connected at least indirectly torque proof with the input E, or the pump wheel P, or the connection between pump wheel P and input E of the force transmission device 1, and can be brought into operative engagement through an operating device 10, with a second friction surface array 8, comprising at least one element bearing a friction surface. The second friction surface array 8 is thus connected torque proof at least indirectly with the output A, either directly, or through a coupling with the turbine wheel T, or through a device 38 for attenuating oscillations. The coupling of the turbine wheel T and the second friction surface array 8 to the output A is thus performed in the simplest case through a so-called drive hub 9. The output A is formed by the shaft unit 2, which simultaneously serves as a transmission input shaft 3 for a transmission unit, arranged subsequently to the force transmission unit 1, which, however, is not shown. The operation of the lockup clutch 6 is performed through the operating device 10, which preferably comprises an axially movable piston element 11, which is supported movable in axial direction, depending on its coupling with an element connected torque proof to the input of the force transmission unit 1, or its connection with the pump wheel P, or the transmission input shaft 3, or the turbine wheel hub 9. The engineering design can be performed in various manners. The sliding movability is shown with a double arrow. Due to the disposition of the lockup clutch 6 in the housing of the force transmission device 1, which is formed by the housing 12 of the torque converter 5, which is formed in the simplest case by the pump wheel shell elements 12.1, 12.2, coupled with the pump wheel P, two chambers 14 and 15 are formed in the interior cavity 13, enclosed by the housing 12, which are divided in axial direction through the piston element 11. The control of the operation of the lockup clutch 6, in particular, of the friction engagement, is thus performed through adjustment of a pressure differential in the two chambers 14, 15, at least partially filled or flowed through by pressure medium, which are formed in the axial direction, respectively between the second friction surface array 8, or the piston element 11, and the housing 12 of the torque converter 5, and the piston element 11, or the face side of the piston element 11, facing the torque converter 5, and the torque converter 5. Thus, the piston element 11 is moved axially relative to the first and the second friction surface array 7, 8, when the pressure in the chamber 15 between housing wall and piston element 11 is higher than the pressure in the pressure chamber 14, and brings the friction surface arrays 7, 8 into mutual engagement. The magnitude of the pressure differential thus determines, if the lockup clutch 6 is operated with or without slippage. For conducting the operating medium and the cooling medium, which are not addressed here in detail, the connections 16 or 17 are associated with the chambers 14, 15. An additional connection, which is not shown here in detail, serves for coupling with the operating space of the torque converter 5.

The chamber 15 can be pressurized independently from the conditions in the torque converter 5, while the chamber 14 depends on the conditions in the torque converter 5. The particular chambers 14 and 15 are furthermore sealed against each other through a seal device 18, disposed between the transmission input shaft 3 and the housing 12. Furthermore, the pressure chamber 15, which is pressurized by the medium that transfers the operating pressure, is sealed relative to the adjacent oil channel, this means the connection 16 in the torque converter 5 through a seal device 18. The seal device 18 is thus provided between the transmission input shaft 3 and the output shaft 9. The coupling of the transmission input shaft 3 with the output shaft 9 thus forms the interface in the connection between the force transmission unit 1 and the transmission unit. The transmission unit in the illustrated embodiment has two channels 19, 20 disposed coaxial, which are used for carrying operating- or pressure media, in particular, in the form of oil. A first inner channel 19 is provided, which is enclosed by a second channel 20 in radial direction. The second outer channel 20 is thus connected with at least one, preferably a plurality of outlet openings 21, arranged in circumferential direction, which lead into the first pressure chamber 14, or which are connected with it. Thus, the particular outlet openings 21 are coupled at the shaft unit 2 in installed position with the operating cavity of the torque converter 5. The middle axes M of the particular outlet openings 21 are thus preferably disposed orthogonal, or at least at an angle with the center axis, and thus the rotation axis R of the transmission input shaft 3.

The seal device 18 is thus disposed in axial direction between the outlet openings 21 and the pressure chambers 15, 14. The shaft unit 2 therefore comprises a first hollow cylindrical element 22, forming the first channel 19. A second hollow cylindrical element 23 is furthermore provided, enclosing the first hollow cylindrical element in circumferential direction, forming the other second channel 20, wherein the first hollow cylindrical element 22 is coupled with the second one, 23, through a press connection 24. The first hollow cylindrical element is pressed into an axial end section 25, which protrudes from the second hollow cylindrical element 23, wherein the first hollow cylindrical element 22 has at least one protrusion 26, provided in radial direction in the end section 25 at the outer circumference, which protrusion 26 is offset in axial direction from a face side 36 of the second hollow cylindrical element 23, forming a groove 27 with it, with the seal device 18 being disposed in the groove 27.

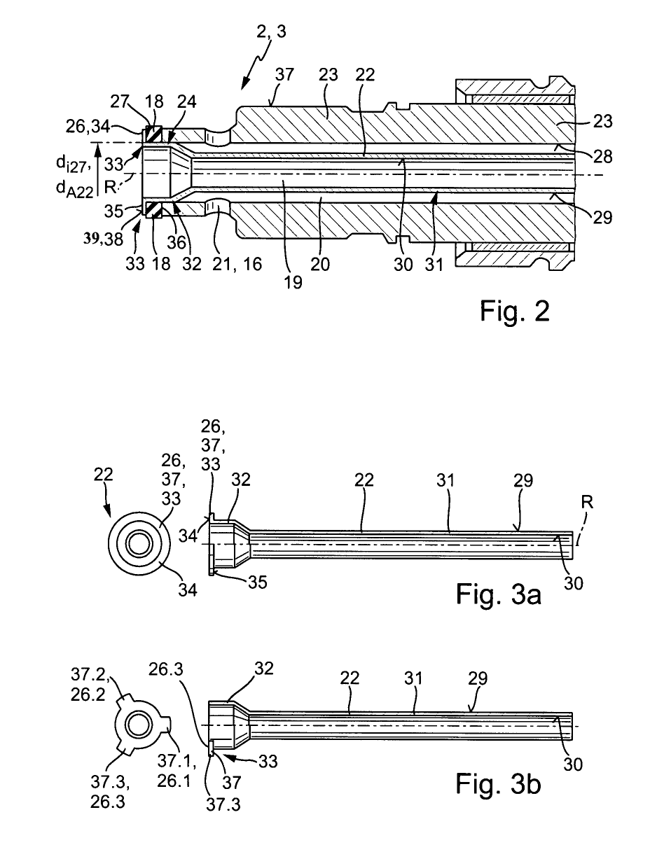

FIG. 2 illustrates the embodiment, according to the invention, of the transmission input shaft 3 with integrated sealing device 18, based on a detail of FIG. 1. The input shaft 3, which comprises the two coaxially disposed channels 19, 20, is provided in at least two pieces for this purpose. The two channels 19, 20 are formed by the particular hollow cylindrical elements 22, 23. The second hollow cylindrical element 23 is provided in the form of a hollow shaft, which can be connected torque proof with the drive hub 9, depending on the embodiment. Thus, the interior circumference 28 of the second hollow cylindrical element 23 and the outer circumference 29 of the first hollow cylindrical element 22 determine the dimensions of the second channel 20. The other first channel 19, coaxially disposed to it, is provided by a first hollow cylindrical element 22, which is inserted into the hollow shaft in axial direction. The first hollow cylindrical element 22 is thus provided preferably in tubular form. It extends through the hollow shaft 23. Analogously, this applies for the channel 19 defined by the interior circumference 30. The first hollow cylindrical element 22 has a first section 31, a second section 32, and an end section 33, wherein the end section 33 belongs to the second section 32, forming the protrusion 25. The particular sections 31 and 32 are characterized through different dimensions in radial direction. The first section 31 forms a wall for the flow of operating fluid through the channel 20. Thus it has a smaller diameter than the interior diameter of the second hollow cylindrical element 23. The second partial area 32 serves to realize a press connection 24 with the second hollow cylindrical element 23, and it is adapted with respect to its outer diameter to the interior diameter of the second hollow cylindrical element, in order to form a press connection. The end section 33 forms the protrusion 25, the axial end section 25 forms the seal carrier. Therefore, the outer diameter in the second section 32 is provided with a press fit relative to the interior diameter of the second hollow cylindrical element 23 in this section. Through the press connection, the two channels 19 and 20 in the shaft unit 2 are provided mostly pressure and fluid tight.

The end section 33 protrudes in axial direction from the second hollow cylindrical element 23 with the end section 25. It has a preferably circumferentially extending ring- or flange shaped protrusion 34, forming a support surface for the seal unit 18 in axial direction on its axial surface 35, facing the second hollow cylindrical element 23. This surface 35 is disposed in installed position, offset in axial direction from the front face 36 of the second hollow cylindrical element 23, thus forming a groove 27 with it, and the outer circumference of the second section 32, extending in this area.

In order to avoid that the groove 27, required for the seal device 18 on the outer circumference 37 of the second hollow cylindrical element 23 of the transmission input shaft 3, leads to an unnecessary weakening of the cross section of the transmission input shaft 3, in particular, of the second hollow cylindrical element 23, provided in the form of the hollow shaft, in the area where the seal device 18 is located, according to the invention, the connection of the second hollow cylindrical element 23 to the first hollow cylindrical element 22 is performed in axial direction, so that the groove 27 is formed. The groove 27 is thus not only machined into the outer circumference 37, thus of the second hollow cylindrical element 23, but it is limited in axial direction by the first and the second hollow cylindrical element 22, 23. The diameter, in particular, the interior diameter, dᵢ₂₇ of the groove 27, is thus determined by the outer diameter d_{A22} of the first hollow cylindrical element 22, in particular, of the tube. Thus, it is required that the tube in its axial end section 25 has at least a protrusion 26 extending in radial direction from the outer circumference 29 of the tube, and extending at least partially in circumferential direction, preferably, a circumferential annular protrusion 34, provided as an annular flange 37. It forms the surface 35, facing the first section 31, or the side surface of the groove 27, with its elements disposed in mounted position in axial direction with an offset between the first and the second hollow cylindrical element 22, 23, forming the groove 27, while the face side 36 of the second hollow cylindrical element 23 forms the second axial defining surface of the groove 27. The seal device 18 is thus fixated in axial direction between the two hollow cylindrical elements 22 and 23 with respect to its position. The groove 27 is thus formed quasi by a tubular flange with the face side of the transmission input shaft 3. This solution permits that the seal device 18 can be mounted on the tube before pressing it in. Thus it is not required to stretch the seal device 18 over the outer shaft diameter of the transmission input shaft 3, in particular of the hollow shaft, during assembly. Thus it is possible, in particular, also to use closed seal elements for outer shaft diameters in the range of more than 20 mm, wherein no particular requirements with respect to the material exist. The groove 27 does not have to be machined anymore, but it is defined through the positioning of the tube, this means the hollow cylindrical element 22 and 23 in axial direction. The end area of the transmission input shaft 3 can be provided with small wall thickness, when provided as a hollow shaft, without additional consideration for the placement of the sealing device 18.

According to a particularly preferred embodiment, the flange 37 at the end section 25 of the tube 27 can additionally take over a sealing function in axial direction. In this case, the flange area 37 in circumferential direction is provided completely circumferential at the end section 25. This flange 37 defines a seal surface 39, or a seal surface area with its face side 38 facing away from the groove 27, while the surface 39 at the flange 37 is being used only partially. The flange 37 can form a sealing pair with the complementary surface areas, wherein the flange abuts to respective surface areas of connection elements in axial direction in a sealing manner, or wherein it is coupled with these respective elements. The forming of a flange 37 with sealing function with a flange surface, extending in circumferential direction in the end section 25 of the first hollow cylindrical element 22, in particular of the tube, is depicted in an exemplary manner in a view from the front in the FIG. 3a in both views for the first hollow cylindrical element 22.

According to a refinement, the flange 37 can also be provided without sealing function. Thus, the particular flange sections can be formed through protrusions 26.1 through 26.3, which are formed in radial direction, and which partially extend in circumferential direction, formed as flange segments 37.1 through 37.n. In this case, the function of the flange 37 is only the formation of a lateral support, or support area sections for the seal device 18. Such an embodiment is shown in two views in FIG. 3b.

The double arrows in the figures illustrate motion- or flow directions.

### DESIGNATIONS

1 force transmission device
2 transmission unit
3 transmission input shaft
4 hydrodynamic component
5 hydrodynamic speed-/torque converter
6 device for circumventing the power transmission at the hydrodynamic component
7 first friction surface array
8 second friction surface array
9 drive hub
10 actuation device
11 piston element
12, 12.1,
12.2 torque converter housing
13 interior space
14 pressure chamber
15 pressure chamber
16 connector
17 connector
18 seal device
19 channel
20 channel
21.1-21.n outlet opening
22 first hollow cylindrical element
23 second hollow cylindrical element
24 press connection
25 end section
26 protrusion
27 groove
28 inner circumference
29 outer circumference
30 inner circumference
31 first section
32 second section
33 end section
34 protrusion
35 surface
36 front face
37 flange
37.1-37.n flange segment
38 face side
39 seal surface
dᵢ₂₇ inner diameter of groove
d_{A22} outer diameter of first hollow cylindrical element

1-9. (canceled)

10: A shaft unit-with a seal function relative to two axial pressure chambers with two coaxial channels for coupling with the two pressure chambers, the two channels disposed coaxially with the rotation axis of the shaft unit and sealed relative to each other through a seal device, the shaft unit comprising:
a seal device;
a first hollow cylindrical element forming a first channel;
a second hollow cylindrical element enclosing the first hollow cylindrical element in a circumferential direction to form a second channel, the first hollow cylindrical element being coupled with the second hollow cylindrical element through a press connection so that the first hollow cylindrical element is pressed together with the second hollow cylindrical element through an axial end section of the first hollow cylindrical section, the first hollow cylindrical element protruding from the second hollow cylindrical element, the first hollow cylindrical element having at least a radially extending protrusion in the end section at an outer circumference, the protrusion being offset in an axial direction from a face side of the second hollow cylindrical element to define a groove, the seal device being disposed in the groove.

11: The shaft as recited in claim 10 wherein the first hollow cylindrical element includes a first section and a second section having different outer dimensions, a first section outer circumference and the second hollow cylindrical element forming the second channel and at least part of the axial extension of the second section pressing into the second hollow cylindrical element and having the protrusion.

12: The shaft unit as recited in claim 11 wherein the protrusion is a circumferential annular protrusion extending in an annular manner around a second section outer circumference of the second section.

13: The shaft unit as recited in claim 12 wherein the protrusion has a front face facing away from the first hollow cylindrical element and forming a seal surface.

14: The shaft unit as recited in claim 12 wherein the protrusion is a rotationally symmetrical flange.

15: The shaft unit as recited in claim 10 further comprising at least one further protrusions, the protrusion and the at least one further protrusion being disposed offset from each other in the circumferential direction at the outer circumference of the end section of the first hollow cylindrical element.

16: The shaft unit as recited in claim 10 wherein the seal device includes at least one O-ring or rectangular ring.

17: The shaft unit as recited in claim 10 wherein the press connection is a transversal press connection.

18: A force transmission device with an input and at least one output comprising:
a hydrodynamic component, the hydrodynamic component further comprising a pump wheel- and a turbine wheel forming at least one workspace fillable with operating fluid; and
a lockup clutch at least partially circumventing force transmission through the hydrodynamic component, the lockup clutch including at least a first friction surface array connected at least indirectly torque proof with the input of the force transmission device or the connection between the force transmission device and the pump wheel, and a second friction surface array, the first friction surface array and the second friction surface array capable of being brought into operating engagement with each other through an operating device;
a first pressure chamber being provided between the operating device and the hydrodynamic component; and
a second pressure chamber being provided between the operating device and a housing, the second pressure chamber fillable with an operating pressure for the operating device,
the output being a shaft unit as recited in claim 10 and the seal device being disposed between the second friction surface array and the output, and the first channel being coupled with the second pressure chamber and the second channel being is coupled with the first pressure chamber.
